(19) United States
(12) Patent Application Publication
(10) Pub. No.: US 2001/0056384 A1
(43) Pub. Date: Dec. 27, 2001

(54) Electronic manual delivery system and method

(76) Inventor: Yukiharu Matsumura, Tokyo (JP)

Correspondence Address: HARNESS, DICKEY & PIERCE, PLC, P.O. BOX 828, BLOOMFIELD HILLS, MI, 48303, US

(21) Appl. No.: 09/878,873

(22) Filed: Jun. 11, 2001

(30) Foreign Application Priority Data
Jun. 14, 2000 (JP) 2000-178099

(51) Int. Cl. G06F 17/60

(52) U.S. Cl. 705/27

(57) ABSTRACT

An electronic manual delivery system for delivering computerized manuals of products to the user terminals accessed through computer networks is provided. The system includes a manual information acquisition part for obtaining manual information related to contents of a manual from a supplier terminal, a manual information registration part for registering the acquired manual information in a database, and a manual information delivering part for transmitting the manual information registered in the database to a user terminal in response to a request from the user terminals.

### BACKGROUND OF THE INVENTION

1. Field of the Invention

This invention is related to an electronic manual delivery system that computerizes manuals such as instruction handbooks, and delivers them on a computer network. Description of the Related Art

Conventionally, various products are sold with paper manuals such as instruction handbooks, and nowadays, handling of products has become complicated because of their sophisticated functions. Consequently, product manuals tend to become thick. Particularly, personal computers and other computer-related products are sold with various types of manuals, and such manuals alone amount to quite a volume.

Production of such a large quantity of paper manuals is undesirable in terms of effective use of resources. Production of paper manuals also causes substantial time and cost burden on product suppliers. On the other hand, it is also difficult for product users to find space to store such a large quantity of paper manuals, understand the contents of manuals that use many technical terms, and find the information they want to know about from a large number of pages of manuals.

### SUMMARY OF THE INVENTION

The present invention has been worked out in view of the inconvenience or shortcoming in the current status of art. It is therefore an object of the present invention to provide an electronic manual delivery system that allows product suppliers to reduce their manual production costs by computerizing their paper manuals and delivering them through a computer network, and also releases users from the need to find space to store paper manuals and simplifies their manual searching work.

According to the first aspect of the present invention, an electronic manual delivery system for delivering computerized manuals of products to the user terminals accessed through a computer network comprises:

a manual information acquisition part for obtaining manual information related to contents of a manual from a supplier terminal;

a manual information registration part for registering the obtained manual information in a database; and

a manual information delivering part for transmitting the manual information registered in the database to a user terminal in response to a request from the user terminals.

According to the invention, a product supplier can promote cost reduction because it is not necessary to produce paper-medium manuals since such manuals are computerized and delivered on computer networks, while users do not have to store manuals, and can easily search the manual contents they want to see.

In the invention set forth above, the manual information acquisition part may comprise a part for requesting the supplier terminal to input manual information for each of predetermined items.

According to this invention, it is possible to easily make a manual in an integrated format because manual data can be inputted by a supplier in accordance with predetermined items.

Additionally, the manual information acquisition part may relate the manual information for each of the item to a symbol figure representing the corresponding item, and the manual information registration part may register the manual information for the respective items together with the related symbol figures in the database.

According to this invention, it is possible to produce manuals that are easy for users to read because relevant symbol figures are assigned to respective items of manuals.

Additionally, the predetermined items may include the items of manual contents which are classified according to the levels of sophistication of product operation, and the electronic manual delivery system may further comprise a part for determining a level of a user in respect of product operation and a part for selecting, based on the determined user levels, an item related to the manual information which is to be browsed at the user terminal from the level-classified items.

According to this invention, it is possible to prevent manual contents from being browsed by a user from being too difficult or too easy to understand.

### BRIEF DESCRIPTION OF THE DRAWINGS

The present invention will be understood more fully from the detailed description given hereinafter with reference to the accompanying drawings of the preferred embodiment of the present invention, which, however, should not be taken to be limitative to the present invention, but are for explanation and understanding only.

FIG. 1 is a schematic diagram showing an embodiment of an electronic manual delivery system according to the present invention;

FIG. 2 is a diagram showing the process of operation of the system;

FIG. 3 is a diagram showing examples of pictographs; and

FIG. 4 is a diagram showing characters that represent the levels of users.

### DESCRIPTION OF THE PREFERRED EMBODIMENT

The present invention will be discussed hereinafter in detail in terms of the preferred embodiment of the present invention with reference to the accompanying drawings. In the following description, numerous specific details are set forth in order to provide a thorough understanding of the present invention. It will be obvious, however, to those skilled in the art that the present invention may be practiced without these specific details.

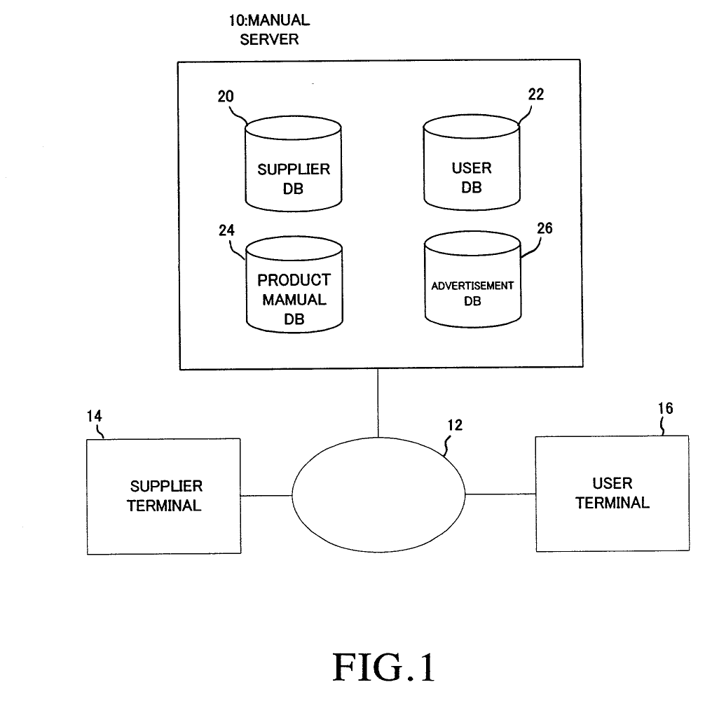

FIG. 1 shows a diagram showing an electronic manual delivery system of an embodiment according to the present invention. As shown in FIG. 1, the electronic manual delivery system comprises a manual server 10. The manual server 10 is a computer system that includes a mass storage unit and various communications interfaces. Many terminals such as personal computers, cell phones, and PDAs are connected to the manual server 10 through computer networks such as the Internet 12. In this system, product suppliers who provide manuals and product users who browse manuals access the manual server 10 from their terminals. Hereinafter, a terminal of a supplier is referred to as a supplier terminal 14, and a terminal of a product user is referred to as a user terminal 16.

As shown in FIG. 1, the manual server 10 has a supplier database 20, a user database 22, a product manual database 24, and an advertisement manual database 26.

The supplier database 20 has the registrations of the product suppliers who deliver their manuals through this system. The user database 22 has the registrations of the users who registered themselves in this system, and the product users who registered the products they bought. The product manual database 24 has the registrations of data of the product manuals that are delivered from this system. The advertisement manual database 26 has the registrations of data of the advertisement manuals that are delivered from this system. As described later, the advertisement manuals are the manuals for advertisement which can be browsed by all users who are registered in this system, whereas the product manuals can be browsed only by the product users who bought products and registered themselves as the users of the products.

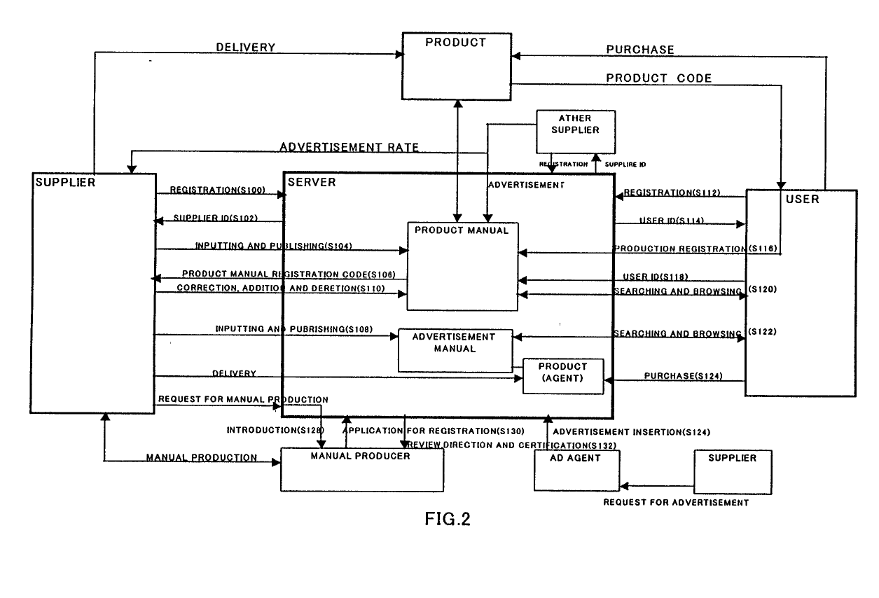

Now, a description will be given of the functions and operation of the electronic manual delivery system in this embodiment. FIG. 2 shows a flow of the operation of this system.

First, a description will be given of supplier registration.

When the supplier terminal 16 accesses the manual server 10 by specifying the URL of the manual server 10, an initial menu screen page is transmitted from the manual server 10. This initial menu screen page includes menu buttons to select menus such as “Supplier Registration” menu, “Product Manual Registration” menu, “Advertisement Manual Registration” menu, “Manual Correction” menu, “System User Registration” menu, “Product User Registration” menu, “Product Manual Browsing” menu, and “Advertisement Manual Browsing” menu. These menus can be selected by clicking the corresponding menu buttons.

The suppliers who wish to deliver their manuals through this system have to register themselves and their manuals in this system in advance.

Suppliers can be registered in this system by selecting the “Supplier Registration” menu on the initial menu screen page. When a supplier selects the “Supplier Registration” menu from its the supplier terminal 14, the manual server 10 transmits a supplier registration screen page to the supplier terminal 14. This supplier registration screen page includes the space of items to be entered such as name, address and telephone number of supplier, name of representative of supplier, division name to be registered, and name of person in charge of registration.

When these items entered are transmitted from the supplier terminal 14 (S100), the manual server 10 issues supplier ID and password, and notifies the supplier of the ID and password (S102). At the same time, the manual server 10 registers the items entered in association with the supplier ID and password in supplier database 20.

Next, a description will be given of manual registration.

As mentioned above, there are two types of manuals: product manuals and advertisement manuals. Product manuals describe in detail directions for usage of products, and they can be browsed only by the users who bought the products and registered themselves as the product users. Advertisement manuals are manual to advertise products with description of their characteristics, and they can be browsed by all users.

Product manuals can be registered by selecting the “Product Manual Registration” menu on the initial menu screen page. When a supplier selects the “Product Manual Registration” menu from its the supplier terminal 14, the manual server 10 requests the supplier terminal 14 to input the supplier ID and password, certifies the ID and password, and then transmit the product manual registration screen page to the supplier terminal 14. This product manual registration screen page has the space of the following items to be entered:

(1) Product Type: the item that shows types of products such as “personal computer”, “minicomponent stereo set,” etc.

(2) Product Installation: the item that describes how to connect and install products.

(3) Product Startup: the item that describes how to start up products, and how to operate products in minimum necessary detail.

(4) Product Usage (A): the item that describes how to use functions of products for beginner-level users.

(5) Product Usage (B): the item that describes how to use functions of products for intermediate-level users.

(6) Product Usage (C): the item that describes how to use functions of products for advanced-level users.

(7) Product Maintenance: the item that describes maintenance and trouble-shooting procedures.

(8) Product Help: the item that describes in the help format how to operate products in breakdown by itemized operation.

(9) Product Option: the item that describes various contents, which suppliers want to mention in their manuals.

Of the items mentioned above, (4)-(6) items corresponds to the manual contents classified into levels of product functions. More items may be provided corresponding to more than three levels of product functions.

A supplier inputs data that describe the contents of a product manual in respect of (1)-(9) items mentioned above. At that time, the supplier can input the data in order from (1) item to have the input screen page for the next item come up when input of data for one of the items is finished. It is also possible to allow a supplier to freely select input items.

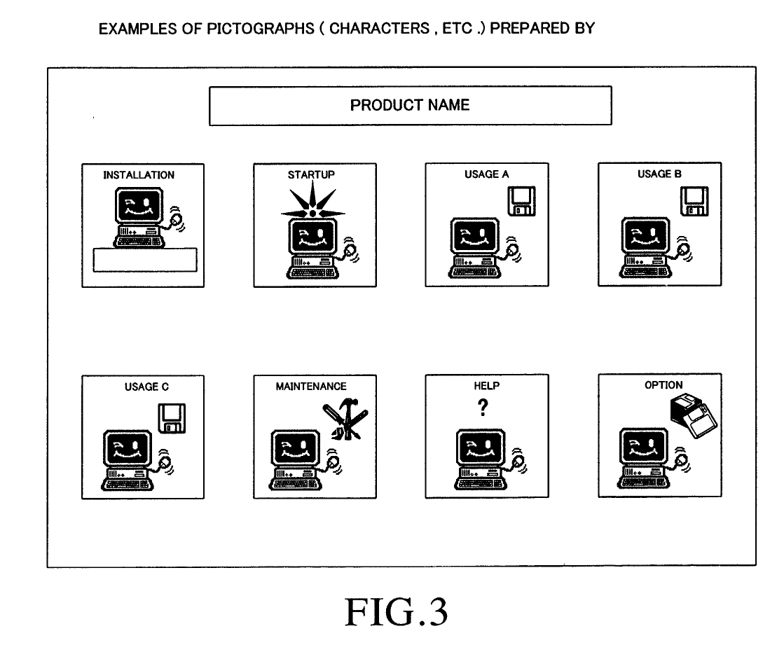

In the manual server 10, pictographs (symbol graphics) are registered to represent the items mentioned above, and the relevant pictographs are assigned to the above-mentioned items of product manuals. FIG. 3 shows the examples of the pictographs that represent respective input items of product manuals. It is also possible to display a pictograph lineup screen page like the one shown in FIG. 3 on the screen of the supplier terminal 14, and only when one of the pictographs is clicked, the clicked pictograph may be assigned to the manual data of the item being input.

When input of data on each item is completed on the product manual registration screen page, the data is transmitted to the manual server 10 as the product manual data (S104). Then, the manual server 10 creates a specific manual ID, notifies the supplier terminal 14 of the manual ID (S106), and registers the received product manual data and the assigned pictograph in the product manual database 24 in association with the manual ID.

As mentioned above, product manuals are registered by inputting the manual contents applicable to respective items according to the items prepared in advance on the manual server 10. Therefore, product manuals produced by product suppliers have coordinated styles that are easy to read. Moreover, as suppliers can assign pictographs of appropriate graphics to respective items of product manuals, they can produce manuals that are easy for users to read.

In the description above, information about production manuals can be input for respective items. As another way of input, for example, it is also possible to use a configuration in which a supplier in advance prepares files which contains manual data for the respective items, selects file names for the respective items, and uploads the applicable files of manual data to the manual server 10.

It should be noted that product manuals that can be registered for respective products are not limited to one type. Multiple types of manuals can be registered for one product. For example, it is possible to register multiple manuals for one product according to the purposes of use of manuals such as practical manuals, training manuals, etc.

The advertisement manuals can be registered by selecting the “Advertisement Manual Registration” menu on the initial menu screen page (S108). The procedures of registration of the advertisement manual are almost the same as that of the product manual, but the input items of the former are different from that of the latter. Or, advertisement manuals may not be itemized, and may be designed to allow inputting in a free format. Inputted advertisement manual data are registered in the advertisement manual database 26, and a specific manual ID is issued for the registered advertisement manual.

Next, a description will be given of manual correction. Manuals can be corrected by selecting the “Manual Correction” menu on the initial menu screen page. When the “Manual Correction” menu is selected at the supplier terminal 14, the manual server 10 transmits to the supplier terminal 14 a screen page to input supplier ID, password and manual ID. When these items are entered, the manual server 10 refers to the product manual database 24 and the advertisement manual database 26, and judges whether the inputted supplier ID, password and manual ID are registered in either of the databases. If registered in either of the databases, the manual server 10 transmits to the supplier terminal 14 a manual correction screen page to correct its manuals, and then the supplier can freely correct its product manuals on the manual correction screen page, including changes, deletions and additions (S110).

As mentioned above, the suppliers who registered their manuals can swiftly make corrections, if they find any inadequacy and misdescription in their manuals. Therefore, they can restrain occurrence of troubles caused by defective description in their manuals like the ones that used to be found in paper manuals.

Next, a description will be given of user registration. User registration is classified into registration of users in this electronic manual delivery system (hereinafter referred to as system user registration) and registration of users as product users (hereinafter referred to as product user registration).

When a user accesses the manual server 10 from the user terminal 16 and selects the “System User Registration” menu on the initial menu screen page, the manual server 10 transmits to the user terminal 16 a system user registration screen page. This system user registration screen page has the space of items to be entered such as name, birth date, sex, address, telephone number, E-mail address, occupation, company name, company address, company phone number, division name, etc. Among these items, the occupation item and company-related items may be entered at the user's option.

When the user enters these items and then clicks the “SEND” button, the entered items are transmitted to the manual server 10 as user data (S112). Then, the manual server 10 issues specific user ID and password, notifies the user of the user ID and password (S114), and registers the received data in association with the user ID and password in the user database 22.

The user who completed the system user registrations can be registered as product users after having bought a product of which the manuals are registered in this electronic manual delivery system. Product users can be registered by selecting the “Product User Registration” menu on the initial menu screen page. When the “Product User Registration” menu is selected at the user terminal 16, the manual server 10 transmits to the user terminal 16 a product user registration screen page. This product user registration screen page includes the space of items to be entered such as product code, user ID, password, name, birth date, sex, telephone number, E-mail address, occupation, company name, company address, company phone number, and division name. Of these items, the product code is the product-specific code number (such as a serial number, for example) attached to the product bought by the user. When the user enters these items from its the user terminal 16 and clicks the “SEND” button, the entered items are transmitted to the manual server 10 as the product user registration data (S116). The manual server 10 identifies the product name from the product code, and registers the product name in association with the product user registration data received from the user in the user database 22. The manual server 10 also addresses various questions about the product to the user of the user terminal 16 to judge the level of the user based on the answers of the user, and registers the user level in the user database 22.

It is also possible to prepare a database where the product codes of the products sold are registered, allow the manual server 10 to refer to this database, and authorize the product user registration only when the product code entered on the product user registration screen page is registered in this database (that means the product is actually sold), in order to authorize, without fail, only the users who bought products to register themselves as product users.

Next, a description will be given of product manual browsing.

Product manuals can be browsed by users by selecting the “Product Manual Browsing” menu on the initial menu screen page. When the “Product Manual Browsing” menu is selected at the user terminal 16, the manual server 10 transmits to the user terminal 16 a screen page to input user ID and product name. When the user ID and the name of the product of which the manual the user wants to browse are inputted and the “SEND” button is clicked, the user ID and product name are transmitted to the manual server 10 (S118). The manual server 10 refers to the user database 22, and judges whether the user ID is registered as a product user of the product (in other words, whether the user is allowed or not to browse the product manual). If the user is registered as the product user, the manual server 10 transmits to the user terminal 16 a manual browsing screen page where the contents of the product manual are displayed, and the user can browse the product manual (S120).

In generating a manual browsing screen page, the manual server 10 selects the contents to be displayed on the screen page according to the user level registered in the user database 22. For example, the manual server 10 shows beginner-level users only elementary items such as the “Product Installation”, “Product Startup”, and “Product Usage (A)”. For intermediate-level users, it omits such elementary items, and only shows the items of the “Product Usage (B)”, “Product Maintenance”, “Product Help”, and “Product Option”. For advanced-level users, it shows the item of the “Product Usage (C)” instead of the “Product Usage (B)”.

At the same time, the manual server 10 shows the pictographs that are assigned to respective items of the manual displayed on the manual browsing screen page. Therefore, it is visually easy for users to understand what contents each item of the manual represents.

With the search functions featured in the manual browsing screen page such as keyword search, category search and image search, as well as the HELP function, users can instantaneously move to other screen pages where the items they want to browse are mentioned.

Advertisement manuals can be browsed by users by selecting the “Advertisement Manual Browsing” menu on the initial menu screen page (S122) almost as the same way as in the case of the product manual browsing mentioned above, except that the user need not be registered as a product user.

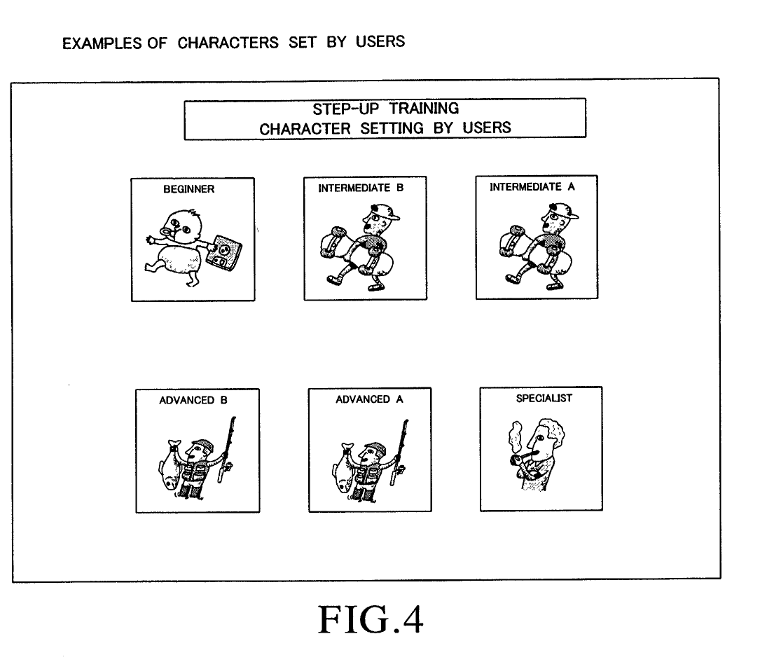

In the system of the present embodiment, it is possible to shows users their levels by displaying character graphics that indicates the user levels. In this case, the user levels may be raised based on the manual contents searched by users or the frequency of manual browsing by users, so that users can know improvement of their levels while enjoying the variation in the character graphics. It is also possible to allow the users to choose their own levels by clicking the character graphics applicable to their levels on the level setting screen page like the one shown in FIG. 4. This function is effective, for example, to return to the initial or earlier level, in case users themselves obviously know they are beginners, or when users feel that the manual contents shown to them are too difficult to understand because their levels are raised much higher than their actual levels based on their records of manual browsing.

The manual delivery system may be provided with a function of presenting appropriate product compositions. In general, as for multiple products interconnected for use, they can be properly connected with each other as they have the same connector and interface specifications, or they have compatibility to properly work when they are connected with each other. The electronic manual delivery system of the present embodiment can judge such compatibility between products based on specifications and functions of respective products, and present the most appropriate product composition pursued by users.

Additionally, the manual delivery system may be provided with a function of advertising related products by allowing suppliers of products to advertise other related products (expansion items, etc.) on the manual browsing screen page of each product manual (S124). Such related products may be the products of other suppliers. In this case, the supplier who advertises products of other suppliers on its manual browsing screen page can collect advertisement rates from them as advertisers.

Additionally, it is also possible to integrate the manual delivery system with an electronic mall by allowing the products, of which the manuals are delivered from the electronic manual delivery system, to be purchased from this system (S126).

Further, the manual delivery system may be provided with a function of intermediating manual producers (S128). In general, production of manuals requires technical know-how. Therefore, it may be possible to introduce manual producers, through intermediation of this electronic manual delivery system, to the suppliers who do not have such know-how. In this case, it is desirable to require manual producers to apply for registrations to secure their quality (S130), and introduce only the manual producers who are reviewed, directed and certified by the operator of this electronic manual delivery system (S132).

What is claimed is:

1. An electronic manual delivery system for delivering computerized manuals of products to the user terminals accessed through computer networks, comprising:
a manual information acquisition part for obtaining manual information related to contents of a manual from a supplier terminal;
a manual information registration part for registering the obtained manual information in a database; and
a manual information delivering part for transmitting the manual information registered in said database to a user terminal in response to a request from said user terminals.

2. An electronic manual delivery system as claimed in claim 1, wherein said manual information acquisition part comprises a part for requesting said supplier terminal to input manual information for each of predetermined items.

3. An electronic manual delivery system as claimed in claim 2, wherein said manual information acquisition part relates the manual information for each of the item to a symbol figure representing the corresponding items, and said manual information registration part registers the manual information for the respective items together with the related symbol figures in said database.

4. An electronic manual delivery system as claimed in claim 2, wherein said predetermined items include the items of manual contents which are classified according to the levels of sophistication of product operation, and
said electronic manual delivery system further comprises:
a part for determining a level of a user in respect of product operation; and
a part for selecting, based on the determined user levels, an item related to the manual information which is to be browsed at said user terminal from said levelclassified items.

5. An electronic manual delivery system as claimed in claim 3, wherein said predetermined items include the items of manual contents which are classified according to the levels of sophistication of product operation, and
said electronic manual delivery system further comprises:
a part for determining a level of a user in respect of product operation; and
a part for selecting, based on the determined user levels, an item related to the manual information which is to be browsed at said user terminal from said level-classified items.

6. An electronic manual delivery method for delivering computerized manual of products to a user terminal through computer networks, comprising:
a step of obtaining manual information related to contents of manuals from a supplier terminal;
a step of registering the obtained manual information in a database; and
a step of transmitting the manual information registered in said database to a user terminal in response to a request from said user terminals.

7. An electronic manual delivery method as claimed in claim 6, wherein said step of obtaining manual information comprises a step of requesting said supplier terminal to input manual information for each of predetermined items.

8. An electronic manual delivery method as claimed in claim 7, wherein said step of obtaining manual information relates the manual information for each of the item to a symbol figure representing the corresponding items, and said step of registering manual information registers the manual information for the respective items together with the related symbol figures in said database.

9. An electronic manual delivery method as claimed in claim 7, wherein said predetermined items include the items of manual contents which are classified according to the levels of sophistication of product operation, and
said electronic manual delivery method further comprises:
a step of determining a level of a user in respect of product operation; and
a step of selecting, based on the determined user levels, an item related to the manual information which is to be browsed at said user terminal from said level-classified items.

10. An electronic manual delivery method as claimed in claim 8, wherein said predetermined items include the items of manual contents which are classified according to the levels of sophistication of product operation, and
said electronic manual delivery method further comprises:
a step of determining a level of a user in respect of product operation; and
a step of selecting, based on the determined user levels, an item related to the manual information which is to be browsed at said user terminal from said level-classified items.
